(19) United States
(12) Patent Application Publication
(10) Pub. No.: US 2005/0045457 A1
(43) Pub. Date: Mar. 3, 2005

(54) Door switch actuating structure for refrigerator

(76) Inventor: Tae-Ho Park, Masan city (KR)

Correspondence Address: FLESHNER & KIM, LLP, P.O. BOX 221200, CHANTILLY, VA, 20153, US

(21) Appl. No.: 10/924,907

(22) Filed: Aug. 25, 2004

(30) Foreign Application Priority Data
Aug. 29, 2003 (KR) 2003-0060320

(51) Int. Cl. H01H 3/16; F25D 23/02

(52) U.S. Cl. 200/61.7; 200/61.62

(57) ABSTRACT

The present invention relates to a door switch actuating structure of a refrigerator. The present invention is a door switch actuating structure for a refrigerator whose storage chamber is formed in a refrigerator main body and is opened and closed by a door supported on the refrigerator main body by means of a hinge unit. The door switch actuating structure comprises a door switch 50 which is provided at the hinge unit 40 and includes a button 52 protruding outwardly from a hinge cover 42; and a driving projection 60 which is provided at a position corresponding to the door switch 50 to selectively push the button 52 of the door switch 50 according to an operation for opening and closing the door 35. According to the present invention configured as above, there are advantages in that a configuration of the door switch 50 and a process for installing the door switch 50 are simplified. In addition, the door switch 50 is not affected by an environment within the refrigerator, and prevents an explosive coolant from exploding. Finally, according to the present invention, there is another advantage in that the maintenance of the door switch 50 may be performed only by opening the hinge cover 42 of the hinge unit 40.

### BACKGROUND OF THE INVENTION

1. Field of Invention

The present invention relates to a refrigerator, and more particularly, to a structure for actuating a door switch which detects an operating state of a door for opening and closing a storage space of the refrigerator.

2. Description of the Prior Art

A refrigerator is provided with a door switch for detecting the opening and closing of a door. On the basis of the detected opened and closed states of the door, an operation of the refrigerator is controlled. That is, when the door is opened, a lamp for illuminating the inside of the refrigerator is turned on in order for a user to look for stored goods easily. In addition, an operation of a refrigeration cycle is switched off in order not to deliver cool air generated in a condenser into the storage chamber when the door is opened.

FIG. 1 is a perspective view showing a major portion of a refrigerator in which a door switch actuating structure according to a prior art is employed. Referring to the figure, a storage chamber 3 is defined in a refrigerator main body 1. An inner case 5 defines inner surfaces of the storage chamber 3. A front end of the inner case 5, i.e. a portion defining an inlet of the storage chamber 3, is formed with a flared portion 6, so that an inlet side of the storage chamber 3 is wider than the interior thereof. A plurality of shelves 7 are installed horizontally at regular intervals in the storage chamber 3. Stored goods are put on the shelves 7.

A door switch 9 is installed at a side of the flared portion 6 formed in the front end of the inner case 5. While a major portion of the door switch 9 is housed in an insulation layer in the inner case 5, only a button thereof is exposed outward. By detecting the opened and closed states of a door 10 which will be described below, the door switch 9 causes a lamp for illuminating the inside of the storage chamber 3 to be turned on and off, and cool air generated in a condenser not to be supplied to the inside of the storage chamber 3 when the door 10 is opened.

The storage chamber 3 of the refrigerator main body 1 is opened and closed by the door 10. An end of the door 10 is connected to the refrigerator main body 1 through hinges (not shown), and rotates about the hinges to open and close the storage chamber 3.

A rear face of the door 10, i.e. a portion defining the inside of the storage chamber 3 when the door 10 is closed is formed by a door liner 12. Door dikes 13 are formed to protrude from at least both ends of edges of the door liner 12. Each of the door dikes 13 is formed with a driving projection 15 at a position corresponding to the door switch 9. The driving projection 15 functions to push the door switch 9 when the door 10 is closed. Reference numeral 16 designates a door basket.

However, the related art door switch actuating structure has the following problems.

That is, since the door switch 9 is installed within the storage chamber 3 of the refrigerator main body 1, it is affected by an environment within the storage chamber 3. For example, the influence of moisture, which may be generated in the storage chamber 3, may cause the door switch 9 not to properly operate.

In order to solve the problem, the door switch 9 is waterproofed in order not to be affected by moisture or is installed in the insulation layer in the inner case 5. However, the waterproof configuration of the door switch 9 causes manufacturing costs to be increased, and the installation of the door switch 9 in the inner case 5 causes the maintenance of the door switch 9 to be difficult.

In addition, sparks may occur during an operation of the door switch 9. Particularly, some of coolants for use in the refrigerator are explosive. Therefore, there is a problem in that an explosive possibility of the coolant is always existent since the door switch 9 is positioned in the storage chamber 3 of the refrigerator main body 1.

Furthermore, in the prior art, a position of the door switch 9 may differ from the design position by means of a foaming pressure of the foam in the process of forming the insulation layer. Particularly, since a relative position of the door switch 9 with respect to the driving projection 15 of the door 10 may be changed, the door switch 9 may not operate in its own way even though the door 10 is closed. In addition, the above problem may occur when a configuration of the door dike 13 of the liner 12 is deformed in the process for forming the insulation layer in the door 10.

Lastly, there are also some problems in that it is cumbersome to temporarily assemble the door switch 9 before the process for forming the insulation layer of the refrigerator main body 1 in order to install the door switch 9 in the inner case 5, and to use an additional housing for protecting an inside of the door switch 9 from foam liquid and a seal for preventing leakage of the foam liquid.

### SUMMARY OF THE INVENTION

Accordingly, the present invention is conceived to solve the aforementioned problems in the prior art. An object of the present invention is to provide a door switch actuating structure which is never affected by an environment within a refrigerator.

Another object of the present invention is to provide a door switch actuating structure wherein an explosive possibility of coolant is removed.

An additional object of the present invention is to provide a door switch actuating structure which has a superior operational reliability.

A further object of the present invention is to provide a door switch actuating structure which consists of a relatively small number of parts and is manufactured by a simplified assembling process.

According to an aspect of the present invention for achieving the objects, there is provided a door switch actuating structure for a refrigerator whose storage chamber is formed in a refrigerator main body and is opened and closed by a door supported on the refrigerator main body by means of a hinge unit. The door switch actuating structure comprises a door switch which is provided at the hinge unit and includes a button protruding outwardly from a hinge cover; and a driving projection which is provided at a position corresponding to the door switch to selectively push the button of the door switch according to an operation for opening and closing the door.

Preferably, the door switch is positioned in the hinge unit at a side of the refrigerator main body, and the driving projection is provided in the hinge unit at a side of the door.

Preferably, the door switch is positioned in the hinge unit at a side of the door, and the driving projection is provided in the hinge unit at a side of the refrigerator main body.

The door switch and driving projection may be provided at positions corresponding to upper ends of the refrigerator main body and door, respectively.

The driving projection may be formed integrally on a decoration cap defining the upper end of the door.

The driving projection may also be formed integrally on a door cap which is mounted to a decoration cap defining the upper end of the door.

More Preferably, the door switch and driving projection are provided at positions corresponding to lower ends of the refrigerator main body and door, respectively.

The driving projection may be formed integrally on a door cap which is mounted to a decoration cap defining the lower end of the door.

According to another aspect of the present invention, there is provided a door switch actuating structure for a refrigerator whose storage chamber is formed in a refrigerator main body and is opened and closed by a door supported on the refrigerator main body by means of a hinge unit. The door switch actuating structure comprises a door switch which is installed at a position on the outside of the refrigerator main body and includes a button protruding outwardly from the refrigerator main body, and a driving projection which is provided at another position on the outside of the refrigerator main body corresponding to the door switch to selectively push the button of the door switch according to an operation for opening and closing the door.

Preferably, the door switch is provided at the hinge unit for supporting the door to the refrigerator main body, and the driving projection is provided at the hinge unit on a side of the refrigerator main body or door on which the door switch is not installed.

More preferably, the door switch is installed at the hinge unit provided at a side of the refrigerator main body, and the driving projection is installed at the hinge unit provided at a side of the door.

More preferably, the driving projection and door switch are installed at positions corresponding to upper ends of the refrigerator main body and door.

According to the door switch actuating structure of the refrigerator of the present invention configured as above, the door switch is never affected by an environment within the refrigerator, causes an explosive possibility due to sparks to be removed, is simply installed, and has a superior operational reliability.

### BRIEF DESCRIPTION OF THE DRAWINGS

The above and other objects, features and advantages of the present invention will become apparent from the following description of a preferred embodiment given in conjunction with the accompanying drawings, in which:

FIG. 1 is a partially perspective view showing a door switch actuating structure of a refrigerator according to a prior art;

FIG. 2 is a perspective view showing an example of a refrigerator in which a preferred embodiment of a door switch actuating structure according to the present invention is employed;

FIG. 3 is a perspective view showing major portion of the embodiment according to the present invention;

FIG. 4a is a view showing a state where a door is closed in the embodiment of the present invention; and

FIG. 4b is a view showing a state where the door is opened in the embodiment of the present invention.

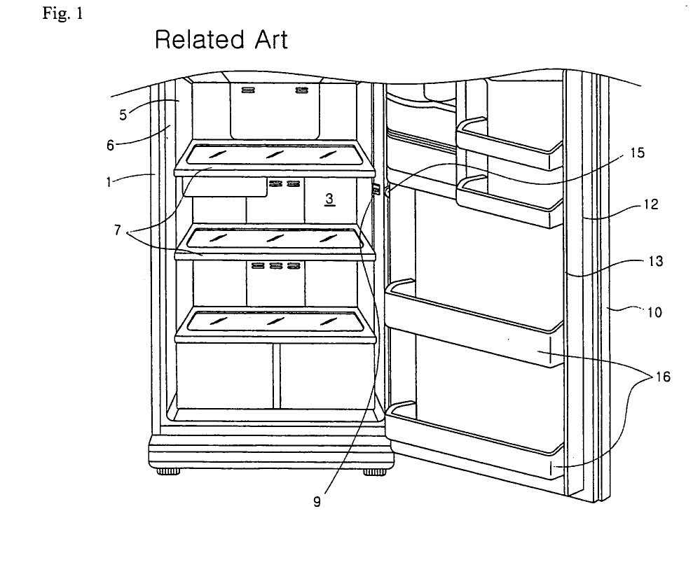

### DETAILED DESCRIPTION OF THE PREFERRED EMBODIMENT

Hereinafter, a preferred embodiment of a door switch actuating structure of a refrigerator according to the present invention will be described in detail with reference to the accompanying drawings.

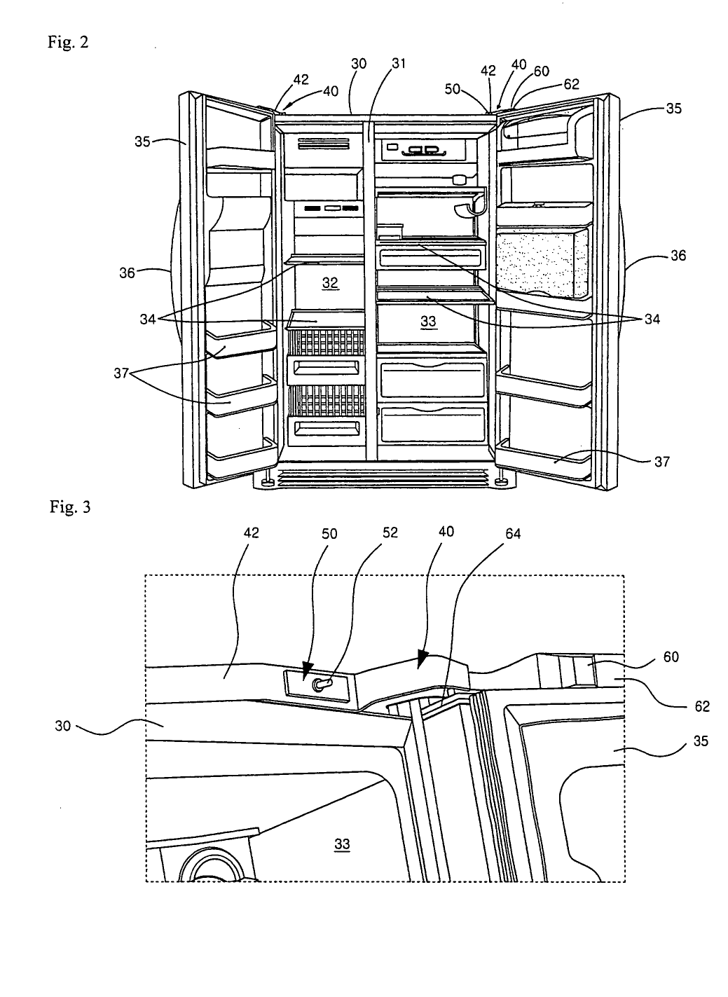

FIG. 2 is a perspective view showing an example of a refrigerator in which a preferred embodiment of a door switch actuating structure according to the present invention is employed. FIG. 3 is a perspective view showing a major portion of the embodiment according to the present invention.

According to the figures, a refrigerator main body 30 is formed with a storage space to be opened to its front face. The storage space consists of freezing and refrigerating chambers 32 and 33 which are partitioned by a barrier 31. The freezing and refrigerating chambers 32 and 33 are formed side by side in the refrigerator main body 30. Goods are stored in the freezing and refrigerating chambers 32 and 33. To this end, the freezing and refrigerating chambers 32 and 33 are provided with a plurality of shelves 34 and additional storage chambers (designated by a reference numeral).

The freezing and refrigerating chambers 32 and 33 are opened and closed by respective doors 35. The doors 35 are connected to both ends of the refrigerator main body 30 to be opened and closed, respectively. In the present embodiment, the doors 35 are opened to be unfolded in the directions opposite to each other, respectively, as shown in FIG. 2.

A front surface of each door 35 is provided with a handle 36 for opening and closing the door. A rear surface of the door 35 is provided with a plurality of baskets 37 for storing the goods.

The door 35 is openably/closably connected to the refrigerator main body 30 through hinge units 40. The hinge units 40, which are provided at an upper end and a lower end of each of the doors 35, respectively, are a rotational center for opening and closing the door. An external appearance of the hinge unit 40 is defined by a hinge cover 42. Parts of the hinge unit 40 are provided in the hinge cover 42. The hinge cover 42 is extended over the refrigerator main body 30 and the door 35.

In the meantime, a door switch 50 is installed at a side of the hinge cover 42 to be exposed. The door switch 50, which is turned on and off by closing and opening the door 35, functions to turn on and off a lamp for illuminating an inside of the freezing or refrigerating chamber 32 or 33 and to stop a heat exchange cycle from operating when the door 35 is opened. The functions of the door switch 50 are not limited thereto, and the door switch 50 may provide signals for performing various functions.

A button 52 of the door switch 50 is exposed and protrudes outward of the hinge cover 42. The button 52 protrudes toward a front of the refrigerator main body 30 at a predetermined distance.

Although in the present embodiment, the door switch 50 is provided within the hinge unit 40 provided at an upper portion of the refrigerator main body 30, it is not necessarily so. For example, the door switch 50 may be provided in the hinge unit provided at a lower portion of the refrigerator main body 30.

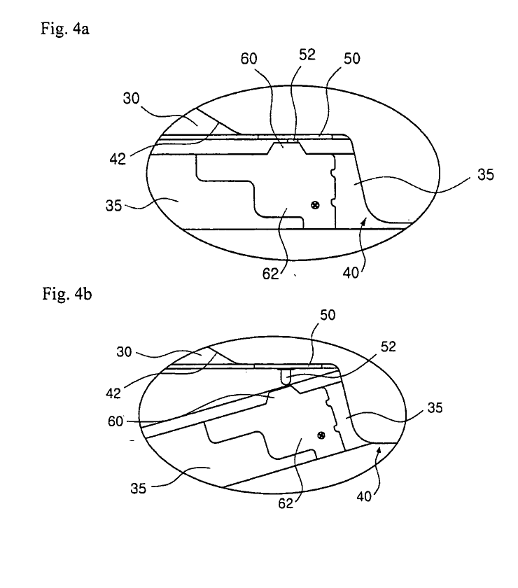

Next, the door 35 is provided with a driving projection 60. The driving projection 60 is formed in. a trapezoidal shape when shown in a plane view (see FIG. 4a). The driving projection 60 should protrude to the extent that a gasket of the door 35 securely comes into close contact with the refrigerator main body 30.

The driving projection 60 protrudes toward the button 52 at a position corresponding to the button 52 of the door switch 50. Therefore, the driving projection 60 is provided at a position adjacent to the hinge unit 40 of an upper end of the door 35.

In the present embodiment, the driving projection 60 is formed at a door cap 62, which is mounted at a decoration cap 64 of an upper end face of the door 35. The driving projection 60 may be formed integrally on the decoration cap 64.

The door switches 50 and the driving projections 60 of the present invention are preferably provided for the doors 35 of the freezing and refrigerating chambers 32 and 33, respectively.

Hereinafter, an operation of the door switch actuating structure of the refrigerator according to the present invention so constructed will be described in detail.

In the refrigerator, the goods are put into or withdrawn from the freezing or refrigerating chamber 32 or 33 by opening the door 35. In addition, the door 35 is closed so that the freezing or refrigerating chamber 32 or 33 do not communicate with the outside and the goods are stored in the freezing or refrigerating chamber 32 or 33 with a inside thereof maintained at a predetermined temperature.

In order for the goods to be put into or taken out from the freezing or refrigerating chamber 32 or 33, the door 35 should be opened. In the present invention, as the door 35 is opened or closed, the door switch 50 operates by means of the driving projection 60 provided in the door 35.

That is, in the state that the door 35 closes the freezing or refrigerating chamber 32 or 33, as shown in FIG. 4a, the driving projection 60 pushes the button 52 of the door switch 50. If the button 52 of the door switch 50 is pushed by the driving projection 60, for example, the lamp for illuminating the freezing or refrigerating chamber 32 or 33 is turned off, and the heat exchange cycle becomes into the state that the heat exchange cycle can operate.

That is, since it is unnecessary to illuminate the inside of the freezing or refrigerating chamber 32 or 33 when the freezing or refrigerating chamber 32 or 33 is closed by the door 35, the lamp is turned off. Further, since the freezing or refrigerating chamber 32 or 33 should be maintained at the predetermined temperature for storing the goods when the freezing or refrigerating chamber 32 or 33 is closed by the door 35, the heat exchange cycle should become into the state that the heat exchange cycle can operate.

Next, if the door 35 is opened in order for the goods to be put into or withdrawn from the freezing or refrigerating chamber 32 or 33, the door switch 50 operates as follows. First, a front end of the door 35 rotates about the hinge units 40, so that the door 35 is opened.

Therefore, the driving projection 60 provided in the upper end of the door 35 begins to go away from the hinge cover 42 at a side of the refrigerator main body 30, and the button 52 of the door switch 50 provided in the hinge cover 42 protrudes forward, which is shown in FIG. 4b.

When the button 52 is not pushed by the driving projection 60, the lamp for illuminating the freezing or refrigerating chamber 32 or 33 is turned on. In addition, the heat exchange cycle becomes into the state that the heat exchange cycle cannot operate.

It is the reason why the lamp illuminates the freezing or refrigerating chamber 32 or 33 in order for a user to put the goods into or take out the goods from the freezing or refrigerating chamber 32 or 33 more easily, since the freezing or refrigerating chamber 32 or 33 has been already opened. In addition, since cool air can be rapidly discharged to the outside of the freezing or refrigerating chamber 32 or 33 when the door 35 is opened, the heat exchange cycle becomes into the state that the heat exchange cycle cannot operate.

According to the door switch actuating structure of the refrigerator of the present invention so constructed, the following advantages can be expected.

First, in the present invention, the door switch is provided in an outer portion of the refrigerator, that is, in the hinge unit. Therefore, since it is unnecessary to employ a structure for coping with an environment within the refrigerator in the hinge unit, manufacturing costs of the door switch may be relatively reduced.

Further, in the present invention, since the door switch is directly installed to the hinge unit, a temporary assembly process or additional parts for installing the door switch as in the prior art is unnecessary. Thus, there is an advantage in that the number of parts and works for installing the door switch is reduced.

In addition, there is convenience in that the door switch is directly accessed by removing only the hinge cover of the hinge unit for the maintenance. There is another advantage in that it is possible to repair the door switch by removing only the hinge cover even when the refrigerator operates.

Furthermore, in the present invention, since the door switch is installed to the outer portion of the refrigerator, there is an additional advantage in that explosive hazard of an explosive coolant due to sparks may be prevented from occurring.

Furthermore, in the present invention, since there is no need for the post-processing or post-working such as a process of injecting foam into parts adjacent to the door switch after installing the door switch, reliability in operation for connecting the door switch and the driving projection is considerably improved.

The scope of the present invention is not limited to the embodiment described and illustrated above but is defined by the appended claims. It will be apparent that those skilled in the art can make various modifications and changes thereto within the scope of the invention defined by the claims.

For example, although the door switch actuating structure of the embodiment of the present invention is applied to a side by side refrigerator, it is not necessarily so. That is, the door switch actuating structure of the present invention may be applied to various kinds of refrigerators.

In addition, it is not always necessary to install the door switch to a refrigerator main body side and install the driving projection to a door side. That is, the door switch may be installed in the hinge cover of the door side, and the driving projection may be installed to the refrigerator main body side.

1. A door switch actuating structure for a refrigerator whose storage chamber is formed in a refrigerator main body and is opened and closed by a door supported on the refrigerator main body by means of a hinge unit, comprising:
a door switch provided at the hinge unit and including a button protruding outwardly from a hinge cover; and
a driving projection provided at a position corresponding to the door switch, thereby selectively pushing the button of the door switch according to an operation for opening and closing the door.

2. The structure as claimed in claim 1, wherein the door switch is positioned in the hinge unit at a side of the refrigerator main body, and the driving projection is provided in the hinge unit at a side of the door.

3. The structure as claimed in claim 1, wherein the door switch is positioned in the hinge unit at a side of the door, and the driving projection is provided in the hinge unit at a side of the refrigerator main body.

4. The structure as claimed in claim 1, wherein the door switch and driving projection are provided at positions corresponding to upper ends of the refrigerator main body and door, respectively.

5. The structure as claimed in claim 4, wherein the driving projection is formed integrally on a decoration cap defining the upper end of the door.

6. The structure as claimed in claim 4, wherein the driving projection is formed integrally on a door cap which is mounted to a decoration cap defining the upper end of the door.

7. The structure as claimed in claim 1, wherein the door switch and driving projection are provided at positions corresponding to lower ends of the refrigerator main body and the door, respectively.

8. The structure as claimed in claim 7, wherein the driving projection is formed integrally on a door cap which is mounted to a decoration cap defining the lower end of the door.

9. A door switch actuating structure for a refrigerator whose storage chamber is formed in a refrigerator main body and is opened and closed by a door supported on the refrigerator main body by means of a hinge unit, comprising:
a door switch installed at a position on the outside of the refrigerator main body and including a button protruding outwardly from the refrigerator main body; and
a driving projection provided at another position on the outside of the refrigerator main body corresponding to the door switch, thereby selectively pushing the button of the door switch according to an operation for opening and closing the door.

10. The structure as claimed in claim 9, wherein the door switch is provided at the hinge unit for supporting the door on the refrigerator main body, and the driving projection is provided at the hinge unit on a side of the refrigerator main body or door on which the door switch is not installed.

11. The structure as claimed in claim 10, wherein the door switch is installed at the hinge unit at a side of the refrigerator main body, and the driving projection is installed at the hinge unit at a side of the door.

12. The structure as claimed in claim 9, wherein the driving projection and door switch are installed at positions corresponding to upper ends of the refrigerator main body and door.
